(19) United States
(12) Patent Application Publication
(10) Pub. No.: US 2024/0171587 A1
(43) Pub. Date: May 23, 2024

(54) REGION-BASED AUTHENTICATION AND ACCESS POLICIES FOR SERVICES

(71) Applicant: Microsoft Technology Licensing, LLC, Redmond, WA (US)

(72) Inventors: Anatoliy PANASYUK, Redmond, WA (US); Yordan I. ROUSKOV, Henderson, NV (US)

(21) Appl. No.: 18/058,324

(22) Filed: Nov. 23, 2022

(51) Int. Cl. H04L 9/40

(52) U.S. Cl. CPC H04L 63/107; H04L 63/0807; H04L 63/0823; H04L 63/20

(57) ABSTRACT

Embodiment described herein enable region-based authentication and/or access policies for services implemented in a cloud computing platform. For example, an authentication request is received from a service, the authentication request including a credential that includes region information that indicates a region the service is assigned to. An identity system authenticates the service and provides an access token that includes the region information. In another embodiment, the identity system determines a level of access to be provided to the service based on whether a criterion of an access policy is satisfied based on the region information and generates an access token indicating the level of access. In another embodiment, the identity system denies issuance of an access token if a criterion of an authentication policy is not satisfied based on the region information. In another embodiment, the identity system obtains region information stored in association with an identifier of the service.

### BACKGROUND

Cloud computing platforms host services across the globe. Such cloud computing platforms implement various access policies to determine whether or not a user and/or service should have access to resources of the cloud computing platform.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein enable region-based authentication and/or access policies for services implemented in a cloud computing platform. For example, an authentication request is received from a service. The authentication request includes a credential that includes region information that indicates a region of the service is assigned to. The service is authenticated and an access token is provided to the service, the access token including region information.

In accordance with another embodiment, a determination of whether at least one criterion of an access policy is satisfied based on the region information is made. A level of access to be provided to the service is determined based at least on the determination of whether at least one criterion of the access policy is satisfied. The service is authenticated. An access token is generated that indicates the service is authenticated and the determined level of access.

In accordance with another embodiment, a determination that at least one criterion of an authentication policy is not satisfied based on the region information is made. Issuance of an access token is denied based at least on the determination that at least one criterion of the authentication policy is not satisfied.

In accordance with one or more embodiments, in lieu of (or in addition to) the credential including the region information, the region information is stored in association with an identifier of the service. The region information is obtained.

In accordance with one or more embodiments, a target service authenticates the service, determines a level of access to be provided to the service, determines that at least one criterion of an authentication policy is not satisfied, and/or obtains region information.

In accordance with one or more embodiments, the service is an instance of a (e.g., global) service.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system for implementing region-based authentication and/or access policies for services in accordance with an example embodiment.

FIG. 2 shows a flowchart of a process for providing an access token that includes region information in accordance with an example embodiment.

FIG. 3 shows a flowchart of a process for providing an access token that indicates a level of access in accordance with an example embodiment.

FIG. 4 shows a flowchart of a process for determining whether to authenticate a service in accordance with an example embodiment.

FIG. 5 shows a flowchart of a process for determining a level of access to a resource in accordance with an example embodiment.

FIG. 6 shows a flowchart of a process for determining a level of access to a resource in accordance with an example embodiment.

FIG. 7 shows a flowchart of a process for issuing a certificate to a service in accordance with an example embodiment.

FIG. 8 shows a block diagram of an example system for implementing region-based authentication and/or access policies for services in accordance with an example embodiment.

FIG. 9 shows a block diagram of an example system for implementing region-based access policies for services in accordance with an example embodiment.

FIG. 10 shows a flowchart of a process for providing an access token that includes region information in accordance with an example embodiment.

FIG. 11 shows a flowchart of a process for providing an access token that indicates a level of access in accordance with an example embodiment.

FIG. 12 shows a flowchart of a process for determining a level of access to a resource in accordance with an example embodiment.

FIG. 13 shows a block diagram of an example system for implementing region-based authentication and/or access policies for services in accordance with an example embodiment.

FIG. 14 shows a block diagram of an exemplary computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Cloud computing platforms may host services (e.g., cloud services) across the globe. Such cloud computing platforms implement various access policies to determine whether or not a user and/or service should have access to resources of the cloud computing platform.

However, in some scenarios, a cloud computing platform service provider or a cloud service hosted by the cloud computing platform desires restricting access to resources of the cloud computing platform based on a region a service is assigned to. For instance, a service provider or service may restrict access to resources to services in the same region as the resource, regions within a group of regions that are allowed access to the resources, regions that are not quarantined, and/or otherwise restrict and/or limit a service's access to resources based on a region a service is assigned to. A service provider or service in accordance with one or more embodiments requires a service to be authenticated based on a region the service is assigned to. In accordance with one or more other embodiments, a service provider or service determines a level of access to be provided to a service based on the region the service is assigned to.

Embodiments described herein are directed to implementing region based authentication and/or access policies for services in a cloud computing platform. For example, an authentication request is received from a service, the authentication request including a credential that includes region information that indicates a region the service is assigned to. An identity system in accordance with an embodiment authenticates the service and provides an access token to the service that includes the region information. In accordance with another embodiment, the identity system determines a level of access to be provided to the service based on whether at least one criterion of an access policy is satisfied based on the region information, authenticates the service, and generates an access token that indicates the determined level of access. In accordance with another embodiment, the identity system determines at least one criterion of an authentication policy is not satisfied based on the region information and denies the issuance of an access token to the service based on the determination. In accordance with one or more other embodiments, in lieu of (or in addition to) the authentication request including the region information, the identity system obtains region information stored in association with an identifier of the service. In accordance with one or more other embodiments, a target service authenticates the service, determines a level of access to provide the service, and/or obtains the region information stored in association with the identifier of the service.

The techniques described herein provide region-based authentication and/or region-based access policy enforcement in a cloud computing platform. In particular, authentication of a service and/or a level of access to a resource that is provided to the service is determined based at least on the region the service is assigned to. In accordance with one or more embodiments, authentication and/or the level of access is determined based on the region to which the service is assigned and additional information present in the credential (e.g., identity information, passwords, pas scodes, attributes, etc.). Examples of a region that a service may be assigned to include, but are not limited to, a geographic region (e.g., a country, a state, a city, a continent, etc.), a group of geographic regions, a location of infrastructure of the cloud computing platform (e.g., the location of a datacenter), and/or any other region-based grouping of services in a cloud computing platform, as would be understood by a person skilled in the relevant art(s) having benefit of this disclosure. In embodiments, the service is assigned to a region by an entity that manages region information for services (e.g., the cloud computing platform or a component of the cloud computing platform). In accordance with one or more embodiments, the region information is stored in association with an identifier of the service in a data store. In accordance with one or more embodiments, the cloud computing platform (or a component thereof) assigns a credential to the service that includes the region information.

Embodiments described herein advantageously provide improvements in security for services in cloud computing platforms. For instance, by using region-based authentication policies and/or region-based access policies, requests to access sensitive data from unauthorized or suspect regions can be prevented and/or limited. Likewise, the techniques described herein can also prevent access by entities in unauthorized or suspect regions to protected network and computing resources. Furthermore, embodiments described herein also improve the functioning of computing devices that might otherwise be impaired if such computing devices were accessed by a malicious entity located in an unauthorized or suspect region.

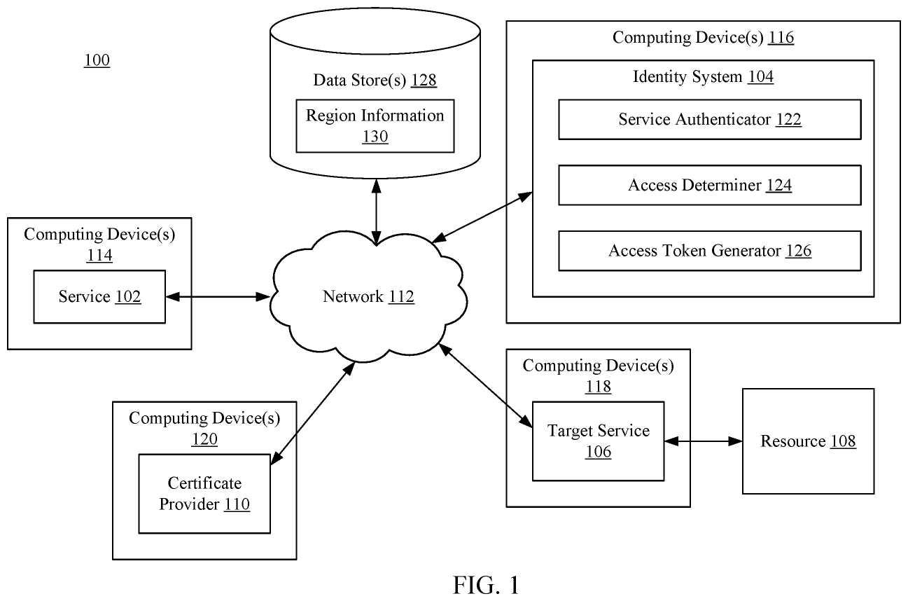

FIG. 1 shows a block diagram of an example system 100 for implementing region-based authentication and/or access policies for services in accordance with an example embodiment. As shown in FIG. 1, system 100 includes one or more computing device(s) 114 (“computing devices 114” hereinafter), one or more computing device(s) 116 (“computing devices 116” hereinafter), one or more computing device(s) 118 (“computing devices 118” hereinafter), one or more computing device(s) 120 (“computing devices 120” hereinafter), resource 108, and one or more data store(s) 128 (“data store 128” hereinafter).

Resource 108 in accordance with one or more embodiments is implemented and/or managed by a managing service (e.g., target service 106, as described further below). Examples of resource 108 include, but are not limited to, physical devices (e.g., computing devices, servers, or network devices), components of physical devices (e.g., processors, memories, storage interfaces), virtual machines, applications (e.g., cloud applications, database applications, web applications, and/or the like), data stores (e.g., databases, blob storage, and/or the like), information objects (e.g., a document, Web page, image, audio file, video file, output of an executable), and/or any other type of resource managed by target service 106.

Data store 128 maintains data accessible to one or more components of system 100. Examples of data store 128 include, but are not limited to, a database, a file repository, and/or any other type of storage suitable for storing data described herein. Examples of data maintained by data store 128 includes, but is not limited to, data files (e.g., documents), database objects (e.g., tables, directories, etc.), structured data, unstructured data, semi-structured data, data containers, etc.

As shown in FIG. 1, data store 128 stores region information 130 that indicates regions to which services are assigned. Each of computing devices 114, 116, 118, and 120 may be one or more of any type of processing device, including, but not limited to, a desktop computer, a server, a mobile or handheld device (e.g., a tablet, a personal data assistant (PDA), a smart phone, a laptop, etc.), an Internet-of-Things (IoT) device, etc. In embodiments, computing devices 114, 116, 118, and/or 120, resource 108, and/or data store 128 are communicatively connected via one or more networks 112. Network(s) 112 may comprise one or more local area networks (LANs), wide area networks (WANs), enterprise networks, the Internet, etc., and may include one or more wired and/or wireless portions.

As shown in FIG. 1, computing devices 114 include a service 102, computing devices 116 include an identity system 104, computing devices 118 include a target service 106, and computing devices 120 include a certificate provider 110. In accordance with an embodiment, service 102 is a service that interacts with or is supported by a cloud computing platform. Examples of service 102 include applications (e.g., cloud applications, database applications, and/or the like), virtual machines, and/or the like. In accordance with an embodiment, service 102 is an instance of a (e.g., global) service. For example, service 102 may be an instance of a service that is operated in multiple regions. In this context, each instance of the service (or “service instance”) is assigned to a corresponding region. In accordance with an embodiment, service 102 is managed by an application platform (not shown in FIG. 1).

Identity system 104 is a system that facilitates the authentication of services (e.g., service 102). In accordance with an embodiment, identity system 104 is an identity provider (e.g., Azure® Active Directory® by Microsoft Corp. of Redmond, Washington). In accordance with another embodiment, identity system 104 is a service-level token provider (e.g., Security Token Service). As will be discussed further below with respect to FIGS. 8 and 9, identity system 104 may be a global identity system, a region-based identity system, sub-region identity system, or a multi-region identity system, in embodiments.

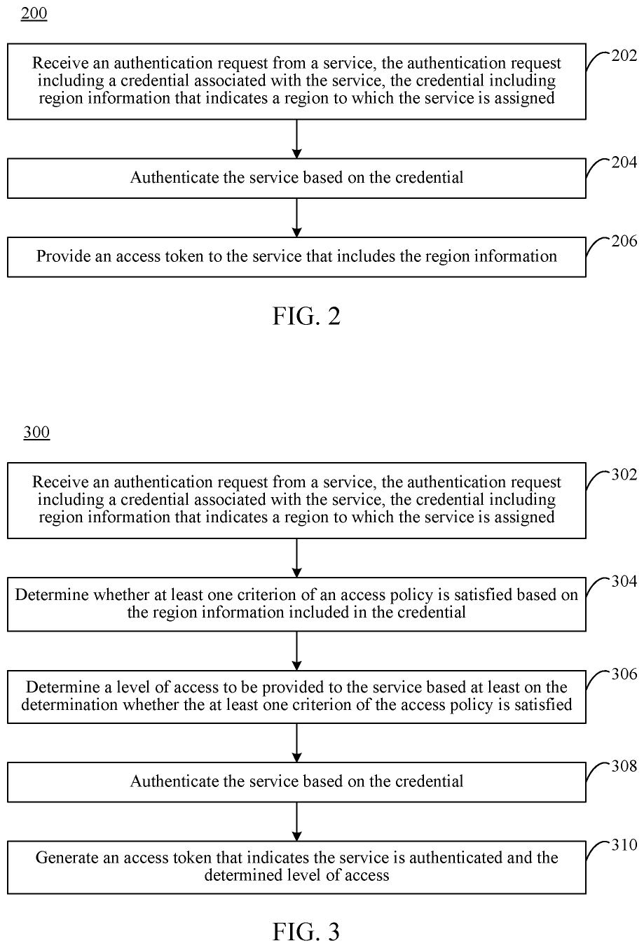

As shown in FIG. 1, identity system 104 includes a service authenticator 122, an access determiner 124, and an access token generator 126. Service authenticator 122 authenticates services (e.g., service 102). For example, service authenticator 122 determines whether or not to authenticate service 102 based at least on an identifier associated with service 102, a credential associated with service 102, region information of service 102 (i.e., that indicates a region that service 102 is assigned to), a level of access provided to service 102 (e.g., as determined by access determiner 124, as will be discussed further below), and/or any other information associated with a service suitable for authenticating the service, as described elsewhere herein. Service authenticator 122 in accordance with an embodiment determines whether or not to authenticate a service based on an authentication policy. Authentication policies may be stored in an external storage accessible to service authenticator 122 (not shown in FIG. 1) and/or stored locally by service authenticator 122 or identity system 104. Additional details regarding authenticating a service are described below with respect to FIGS. 2-4.

Access determiner 124 determines whether a service (e.g., service 102) should have access (e.g., to a target service and/or to a resource) and optionally a level of the access to be provided to the service. Example levels of access include, but are not limited to, no access, limited access, full access, and/or heightened access. In accordance with an embodiment, access determiner 124 determines a level of access to be provided to the service prior to service authenticator 122 authenticating the service. In accordance with another embodiment, access determiner 124 determines a level of access to be provided to the service subsequent to service authenticator 122 authenticating the service. Additional details regarding access determiner 124 (or identity system 104 or another component of identity system 104) determining a level of access to be provided to a service are described below with respect to FIG. 3.

Access token generator 126 generates and issues access tokens to services (e.g., service 102) that enable the services to access target services (e.g., target service 106) and/or resources managed by the target services (e.g., resource 108). In accordance with an embodiment, access token generator 126 includes region information associated with the service in the generated access token. Additional details regarding generating and issuing access tokens are described below with respect to FIGS. 2 and 3.

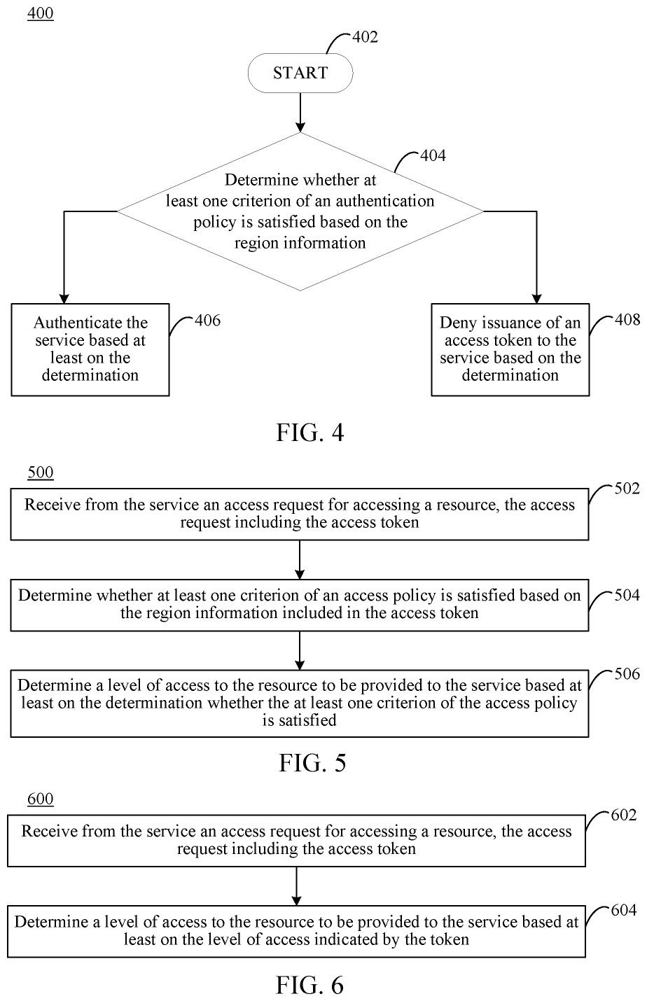

Target service 106 is intended to represent a service that communicates with requesting services (e.g., service 102) for the purpose of providing the requesting service with access to a resource. Examples of target service 106 include, but are not limited to, a resource manager (e.g., a resource provider) that manages resources (e.g., resource 108), an application of the resource (e.g., an application of resource 108 that enables the requesting service to access and/or interact with resource 108), a service manager that manages services (i.e., for establishing service-to-service communication), and a destination service (i.e., a service that the requesting service is requesting a connection with). Additional details regarding target service 106 and providing a service access to a resource are discussed further below with respect to FIGS. 5 and 6.

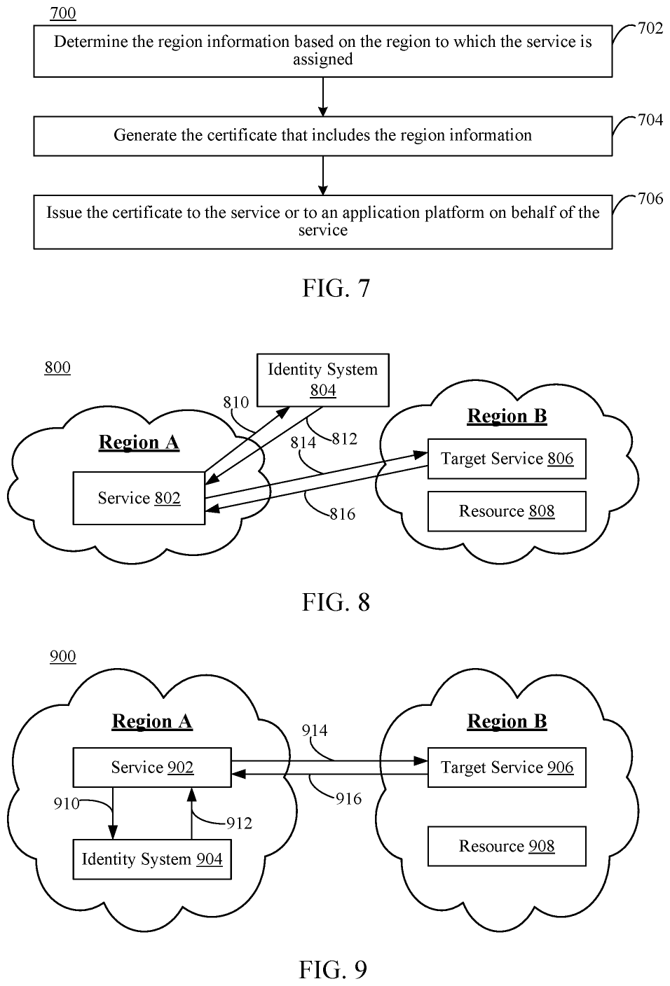

Certificate provider 110 issues certificates to services (e.g., service 102). In accordance with an embodiment, certificate provider 110 is a certificate authority that stores, signs, and/or issues certificates to services. In accordance with another embodiment, certificate provider 110 operates on behalf of a certificate authority to issue certificates owned by the certificate authority to services. Additional details regarding issuing certificates to services are discussed further below with respect to FIG. 7.

In accordance with one or more embodiments, service 102 of FIG. 1 obtains an access token from identity system 104 in system 100. In order to obtain the access token, service 102 transmits an authentication request to identity system 104 that includes a credential that includes region information that indicates a region that service 102 is assigned to. In accordance with an embodiment, service 102 transmits an access request to target service 106 for requesting access to target service 106 and/or resource 108. In this context, target service 106 determines an access token is required to grant service 102 access and redirects service 102 to identity system 104. In either context, identity system 104 may determine whether or not to generate and/or issue an access token based at least on the authentication request in various ways, in embodiments.

In view of the foregoing context, FIG. 2 will now be described. FIG. 2 shows a flowchart 200 of a process for providing an access token that includes region information in accordance with an example embodiment. In accordance with an embodiment, identity system 104 of FIG. 1 operates according to flowchart 200. Not all steps of flowchart 200 need be performed in all embodiments. Further structural and operational embodiments will be apparent to persons skilled in the relevant art(s) based on the following description of FIG. 2.

Flowchart 200 begins with step 202. In step 202, an authentication request is received from a service. The authentication request includes a credential associated with the service. The credential includes region information that indicates a region to which the service is assigned. For example, identity system 104 of FIG. 1 receives an authentication request from service 102. In this context, the authentication request includes a credential associated with service 102, the credential including region information that indicates a region to which service 102 is assigned to. Examples of a credential include, but are not limited to, an identity token (e.g., an identity token that was provided to service 102 by an application platform based on a prior authentication of the application platform by identity system 104 (or another identity component of system 100 not shown in FIG. 1)), an application key, a certificate issued to service 102 or to an application platform on behalf of service 102, an identifier associated with service 102, a device identifier corresponding to a hardware authentication device associated with service 102 (e.g., a hardware token, a YubiKey® hardware authentication device by Yubico AB, a smart card, a one-time-password (OTP) token authenticator), a value derived from a device identifier corresponding to a hardware authentication device associated with service 102, and/or any other credential associated with service 102 that service 102 (or an application platform on behalf of service 102) presents to identity system 104 for the purpose of determining an authenticity of service 102.

In step 204, the service is authenticated based on the credential. For example, service authenticator 122 authenticates service 102 based on the credential received from service 102 in step 202. Service authenticator 122 in accordance with an embodiment evaluates the credential against at least one criterion of an authentication policy to determine if service 102 should be authenticated. For instance, service authenticator 122 may access information stored by identity system 104, information stored by a component of identity system 104, or information otherwise accessible to service authenticator 122 to verify the credential satisfies at least one criterion of an authentication policy. Additional details regarding the authentication of service 102 are described further below with respect to FIG. 4. For the sake of this example, it will be assumed that service authenticator 122 authenticates service 102 (e.g., the at least one criterion of the authentication policy is satisfied).

In step 206, an access token is provided to the service. The access token includes the region information. For example, access token generator 126 of FIG. 1 provides an access token to service 102, the access token including the region information that was included in the authentication request. In accordance with an embodiment, access token generator 126 signs the access token using a private signing key of a signing key pair associated with identity system 104. In this context, other services, other applications, and/or other components of system 100 are able to use a public signing key of the signing key pair to verify that the access token was provided to service 102 by identity system 104.

As discussed above, identity system 104 of FIG. 1 may determine whether or not to generate and/or issue an access token to a service in various ways, in embodiments. For instance, identity system 104 in accordance with one or more embodiments determines a level of access to be provided to service 102. For example, FIG. 3 shows a flowchart 300 of a process for providing an access token that indicates a level of access in accordance with an example embodiment. In accordance with an embodiment, identity system 104 operates according to flowchart 300. Not all steps of flowchart 300 need be performed in all embodiments. Further structural and operational embodiments will be apparent to persons skilled in the relevant art(s) based on the following description of FIG. 3.

Flowchart 300 begins with step 302. In step 302, an authentication request is received from a service. The authentication request includes a credential associated with the service. The credential includes region information that indicates a region to which the service is assigned. For example, identity system 104 of FIG. 1 receives an authentication request from service 102 in a similar manner described above with respect to step 202 of FIG. 2.

In step 304, a determination of whether at least one criterion of an access policy is satisfied is made based on the region information included in the credential. For example, access determiner 124 of FIG. 1 in accordance with an embodiment determines whether at least one criterion of an access policy is satisfied based on region information included in the credential received in step 302. In accordance with an embodiment, access determiner 124 accesses policy information stored by identity system 104, policy information stored by a component of identity system 104, policy information stored by computing devices 116, and/or policy information otherwise accessible to access determiner 124 to verify that the region information satisfies at least one criterion of an access policy. Examples of access policies include, but are not limited to, conditional access policies and role-based access control (RBAC) policies. In accordance with an embodiment, access determiner 124 evaluates the region information against at least one criterion of multiple access policies to determine if each of the respective criterion are satisfied. Example criterion of an access policy include, but are not limited to, whether a region to which service 102 is assigned to is a quarantined region, whether the region to which service 102 is assigned to is a region that is allowed access, whether a risk level associated with the region to which service 102 is assigned is a risk level accepted by the access policy, and/or any other criterion that access determiner 124 may use to evaluate the region information included in the credential. For the sake of this example, it will be assumed that at least one criterion of an access policy is satisfied.

In step 306, a level of access to be provided to the service is determined based at least on the determination of whether the at least one criterion of the access policy is satisfied. For example, access determiner 124 of FIG. 1 determines a level of access to be provided to service 102 based at least on the determination made in step 304. The determined level of access may include, but is not limited to, no access, limited access, full access, and/or heightened access.

In step 308, the service is authenticated based on the credential. For example, service authenticator 122 of FIG. 1 authenticates service 102 based on the credential received in step 302 in a similar manner to that described above with respect to step 204 of flowchart 200 of FIG. 2. In accordance with one or more embodiments, service authenticator 122 authenticates service 102 based on the level of access determined in step 306. For instance, service authenticator 122 in accordance with an embodiment authenticates service 102 if the level of access determined in step 306 is limited access, full access, and/or heightened access.

In step 310, an access token is generated. The access token indicates the service is authenticated and the determined level of access. For example, access token generator 126 of FIG. 1 generates an access token that indicates service 102 is authenticated and the level of access determined in step 306. In accordance with an embodiment, access token generator 126 also includes the region information included in the credential that was included in the access request received in step 302 in the access token, as discussed above with respect to step 206 of flowchart 200 of FIG. 2. In accordance with an embodiment, access token generator 126 signs the access token using a private signing key of a signing key pair associated with identity system 104.

Steps of flowchart 300 may be performed in a different order than that shown in FIG. 3. For instance, while FIG. 3 depicts the authentication of step 308 being performed subsequent to the determinations made in steps 304 and 306, it is also contemplated herein that the authentication of step 308 may be performed prior to step 304 and/or 306. For example, access determiner 124 in accordance with an embodiment performs step 304 and/or step 306 subsequent to service authenticator 122 having authenticated service 102 based on the credential.

Service authenticator 122 of FIG. 1 may determine an authenticity of service 102 in various ways, in embodiments. For example, FIG. 4 shows a flowchart 400 of a process for determining whether to authenticate a service in accordance with an example embodiment. In accordance with an embodiment, identity system 104 of FIG. 1 operates according to flowchart 400. Not all steps of flowchart 400 need be performed in all embodiments. Further structural and operational embodiments will be apparent to persons skilled in the relevant art(s) based on the following description of FIG. 4.

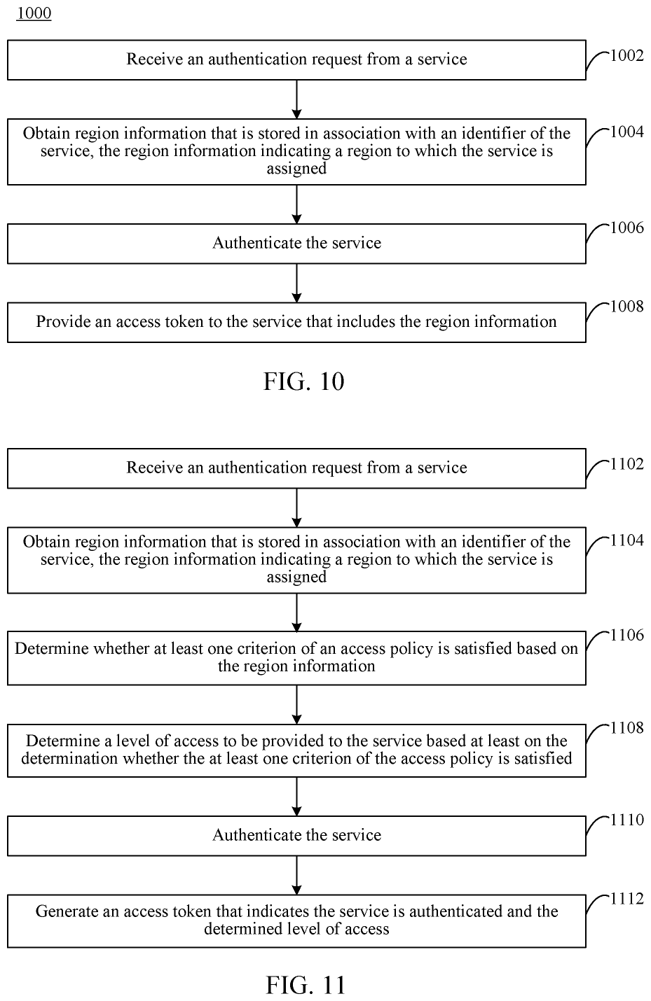

Flowchart 400 begins with step 402. In accordance with an embodiment, step 402 includes receiving an authentication request. For example, in step 402, service authenticator 122 of FIG. 1 receives an authentication request from service 102 in a similar manner described above with respect to steps 202 of FIG. 2 and 302 of FIG. 3. In accordance with another embodiment, step 402 includes determining a level of access to be provided to a service. For example, in step 402, access determiner 124 determines a level of access to be provided to service 102 in a similar manner described above with respect to steps 304 and 306 of FIG. 3. In accordance with another embodiment, step 402 includes obtaining region information that is stored (e.g., in data store 128 of FIG. 1) in association with an identifier of a service. Additional details regarding obtaining region information are discussed further below with respect to FIGS. 10-12.

In step 404, a determination of whether at least one criterion of an authentication policy is satisfied is made based on region information. For example, service authenticator 122 determines whether at least one criterion of an authentication policy is satisfied based on region information that indicates a region service 102 is assigned to. As discussed above with respect to FIGS. 2 and 3, in some embodiments, the region information is included in the credential included in an authentication request received from service 102. In accordance with some other embodiments, and as will be discussed further below with respect to FIGS. 10-12, the region information is obtained by service authenticator 122 or another component of identity system 104. Service authenticator 122 in accordance with an embodiment accesses policy information stored by identity system 104, policy information stored by a component of identity system 104, policy information stored by computing devices 116, and/or policy information otherwise accessible to service authenticator 122 to verify at least one criterion of an authentication policy is satisfied based on the region information. Example criterion of an authentication policy include, but are not limited to, whether a region to which service 102 is assigned to is a quarantined region, whether the region to which the service is assigned to is a region that is allowed access, whether the region to which the service is assigned to corresponds to a region that identity system 104 is associated with (e.g., a region that identity system 104 is configured to authenticate services for, a region that identity system 104 is assigned to, and/or the like), whether a risk level associated with the region to which the service is a risk level accepted by the authentication policy, and/or any other criterion that service authenticator 122 may use to evaluate the region information. If at least one criterion of the authentication policy is satisfied, flowchart 400 continues to step 406. If at least one criterion of the authentication policy is not satisfied, flowchart 400 continues to step 408.

It is also contemplated herein that service authenticator 122 in accordance with one or more alternative embodiments evaluates the region information against multiple criteria of an authentication policy and/or respective criterion of multiple authentication policies. In this context, service authenticator 122 may determine if each criterion is satisfied, determine if a number of criterion is satisfied (e.g., at least a number of criterion that meets a predetermined threshold), and/or determine if a predetermined combination of criterion is satisfied. Depending on the implementation, if each criterion is satisfied, if the number of criterion satisfied meets the predetermined threshold, and/or if a predetermined combination of criterion is satisfied, flowchart 400 continues to step 406. Otherwise, flowchart 400 continues to step 408.

In step 406, the service is authenticated based at least on the determination. For example, service authenticator 122 authenticates service 102 based at least on the determination made in step 404. Service authenticator 122 authenticates service 102 in a similar manner to that described elsewhere herein. Depending on the implementation, flowchart 400 continues to determining whether at least one criterion of an access policy is satisfied (e.g., as described above with respect to steps 304 and 306 of FIG. 3) or to issuing an access token to service 102 (e.g., as described above with respect to steps 206 of FIGS. 2 and/or 310 of FIG. 3).

In step 408, issuance of an access token to the service is denied based on the determination. For example, service authenticator 122 denies issuance of an access token to service 102 based on the determination made in step 404. For instance, service authenticator 122 in accordance with an embodiment denies issuance of the access token to service 102 if no criterion of an access policy is satisfied. In accordance with another embodiment, service authenticator 122 denies issuance of the access token to service 102 if at least one criterion of an access policy is not satisfied. In accordance with another embodiment, service authenticator 122 denies issuance of the access token to service 102 if a predetermined number of criteria of an access policy are not satisfied. In accordance with another embodiment, service authenticator 122 denies issuance of the access token to service 102 if a predetermined combination of criterion is not satisfied. In accordance with an embodiment, service authenticator 122 transmits a message to service 102 that indicates issuance of the access token was denied. In accordance with a further embodiment, the message includes a reason for the denial (e.g., the region service 102 is assigned to is a quarantined region, the region service 102 is assigned to is not on a list of regions service authenticator 122 authenticates services for, a risk level of the region service 102 is assigned to exceeds a level accepted by the authentication policy, etc.).

As discussed above, target service 106 of FIG. 1 in accordance with one or more embodiments determines whether a service should have access to a resource and, if so, provide access to the resource. Target service 106 may determine whether a service should have access in various ways, in embodiments. For example, FIG. 5 shows a flowchart 500 of a process for determining a level of access to a resource in accordance with an example embodiment. In accordance with an embodiment, target service 106 operates according to flowchart 500. Not all steps of flowchart 500 need be performed in all embodiments. Further Structural and operational embodiments will be apparent to persons skilled in the relevant art(s) based on the following description of FIG. 5.

Flowchart 500 begins with step 502. In step 502, an access request for accessing a resource is received from a service. The access request includes an access token. For example, target service 106 receives an access request for accessing resource 108 from service 102, the access request including an access token (e.g., an access token issued by identity system 104). In accordance with an embodiment, the access request includes the region information that indicates the region service 102 is assigned to.

In step 504, a determination of whether at least one criterion of an access policy is satisfied is made based on the region information included in the access token. For example, target service 106 of FIG. 1 determines whether at least one criterion of an access policy is satisfied based on the region information included in the access token included in the access request received in step 502. In accordance with an embodiment, target service 106 access policy information stored by target service 106, policy information stored by computing devices 118, and/or policy information otherwise accessible to target service 106 to verify that the region information included in the access token satisfied at least one criterion of an access policy. Examples of access policies include, but are not limited to, conditional access policies and RBAC policies. In accordance with an embodiment, target service evaluates the region information against at least one criterion of multiple access policies to determine if each of the respective criterion are satisfied. Example criterion of an access policy include, but are not limited to, whether a region to which service 102 is assigned to is a quarantined region, whether the region to which the service is assigned to is a region that is allowed access to resource 108, whether a risk level associated with the region to which the service is a risk level accepted by the access policy, and/or any other criterion that target service 106 may use to evaluate the region information included in the access token.

In step 506, a level of access to the resource to be provided to the service is determined based at least on the determination of whether the at least one criterion of the access policy is satisfied. For example, target service 106 of FIG. 1 determines a level of access to resource 108 to be provided to service 102 based at least on the determination made in step 504. The determined level of access may include, but is not limited to, no access, limited access, full access, and/or heightened access. As a non-limiting example, target service 106 in accordance with an embodiment determines in step 504 that at least one criterion of an access policy is not satisfied, a predetermined number of criteria of the access policy are not satisfied, and/or a combination of criteria of the access policy are not satisfied. In this context, target service 106 determines that a “no access” level of access to resource 108 is to be provided to service 102. In another non-limiting example, target service 106 determines in step 504 that a risk level associated with the region to which service 102 is assigned to indicates a potential risk and therefore determines that a “limited access” level of access to resource 108 is to be provided to service 102. In another non-limiting example, target service 106 determines in step 504 that at least one criterion of an access policy is satisfied and that a “full access” level of access to resource 108 is to be provided to service 102. Such non-limiting examples are provided for illustrative purposes. It is further contemplated that other combinations of determinations of whether criteria of access policies are satisfied and determinations of levels of access may be made by target service 106, as described herein.

As discussed above, target service 106 determines whether a service should have access in various ways, in embodiments. For example, FIG. 6 shows a flowchart 600 of a process for determining a level of access to a resource in accordance with an example embodiment. In accordance with an embodiment, target service 106 operates according to flowchart 600. Not all steps of flowchart 600 need be performed in all embodiments. Further Structural and operational embodiments will be apparent to persons skilled in the relevant art(s) based on the following description of FIG. 6.

Flowchart 600 begins with step 602. In step 602, an access request for accessing a resource is received from a service. The access request includes an access token. For example, target service 106 of FIG. 1 receives an access request for accessing resource 108 from service 102, the access request including an access token (e.g., an access token issued by identity system 104). In accordance with an embodiment the access token includes the level of access determined by access determiner 124, as described above with respect to flowchart 300 of FIG. 3. In accordance with an embodiment, the access request includes the region information that indicates the region service 102 is assigned to.

In step 604, a level of access to the resource to be provided to the service is determined based at least on the level of access indicated by the access token. For example, target service 106 of FIG. 1 determines a level of access to resource 108 to be provided to service 102 based at least on the level of access indicated by the access token included in the access request received in step 602. Example levels of access include, but are not limited to, no access, limited access, full access, and/or heightened access. In accordance with an embodiment, target service 106 determines that the level of access to resource 108 to be provided to service 102 is equivalent to the level of access indicated by the access token (i.e., no access based on an access token that indicates no access, limited access based on an access token that indicates limited access, etc.). In accordance with another embodiment, target service 106 determines that the level of access to resource 108 to be provided to service 102 is different than the level of access indicated by the access token. For instance, target service 106 in accordance with an embodiment determines that the level of access indicated by the access token does not meet an access policy associated with resource 108 (e.g., the access token indicates a limited access level of access and the access policy requires full access to access resource 108). In accordance with another embodiment, target service 106 determines that the service should be provided a higher level of access to a resource based on the level of access indicated by access token (e.g., the access token indicates a limited level of access and an access policy associated with resource 108 allows full access to resource 108 as long as some level of access (i.e., other than no access) is indicated by the access token).

### III. Example Embodiments for Generating a Credential

As discussed above, embodiments of identity systems (e.g., identity system 104) authenticate services, determine levels of access to be provided to services, and/or issue access tokens to services based on region information that indicates a region to which the service is assigned. As discussed elsewhere herein, credentials provided by a service to an identity system (e.g., by including the credential in an authorization request) may include region information that indicates the region to which the service is assigned to. In accordance with one or more embodiments, the credential is a credential that was previously provided to the service by another entity.

For example, a credential in accordance with an embodiment is an identity token that was provided to the service by an application platform based on a prior authentication of the application platform by an identity system. For instance, an application platform in accordance with an embodiment hosts services (e.g., service 102 of FIG. 1). The application platform is assigned to a region (e.g., by a cloud computing platform the application is associated with). In this context, services hosted by the application platform are also assigned to the region. If a service (e.g., service 102) requires an identity token, the application platform authenticates with an identity system (e.g., identity system 104) by providing a credential of the application platform that includes region information that indicates the region the application platform is assigned to. If the identity system determines the application platform is authentic (e.g., based at least on the credential, the region information, and/or an authentication policy), the identity system issues an identity token to the application platform that includes the region information. The application platform provides the identity token to the service. In this context, the service is assigned to a region by the application platform authenticating with an identity system on behalf of the service.

In accordance with another embodiment, a certificate provider, such as certificate provider 110 of FIG. 1, provides a service (e.g., service 102) with a credential that includes region information. For example, FIG. 7 shows a flowchart 700 of a process for issuing a certificate to a service in accordance with an example embodiment. In accordance with an embodiment, certificate provider 110 operates according to flowchart 700. Not all steps of flowchart 700 need be performed in all embodiments. Further structural and operational embodiments will be apparent to persons skilled in the relevant art(s) based on the following description of FIG. 7.

Flowchart 700 begins with step 702. In step 702, region information is determined based on a region to which a service is assigned. For example, certificate provider 110 of FIG. 1 determines region information based on a region to which service 102 is assigned. In accordance with an embodiment, certificate provider 110 determines the region information by accessing region information stored in association with an identifier of service 102, as will be discussed further below with respect to FIGS. 10-12. Alternatively, certificate provider 110 determines the region information based on a certificate request received from service 102, the certificate request including an initial credential of service 102 that indicates the region service 102 is assigned to. In accordance with another embodiment, certificate provider 110 is a subcomponent of the entity that generates the instance of service 102. In this context, certificate provider 110 determines the region information of service 102 as part of the generation of the instance of service 102.

In accordance with an alternative embodiment, certificate provider 110 determines the region information based on a region an application platform is assigned to. For instance, as discussed above, an application platform may host a service (e.g., service 102). In this context, the application platform obtains a platform certificate from certificate provider 110 on behalf of services hosted by the application platform. In this context, certificate provider 110 determines region information based on a region the application platform is assigned to (i.e., which also indicates the region the service is assigned to).

In step 704, a certificate that includes the region information is generated. For example, certificate provider 110 generates a certificate that includes the region information that indicates the region to which service 102 is assigned. In accordance with an embodiment, certificate provider 110 is a certificate authority that creates, maintains, and issues certificates. In this context, certificate provider 110 in accordance with an embodiment includes the region information in the certificate as part of creating the certificate. Alternatively, certificate provider 110 inserts or otherwise associates the region information with an existing certificate prior to issuing the certificate to service 102. In accordance with an embodiment, certificate provider 110 issues certificates on behalf of a certificate authority. In this context, certificate provider 110 inserts or otherwise associates the region information with a certificate prior to issuing the certificate to service 102.

In step 706, a certificate is issued to the service or to an application platform on behalf of the service. For example, certificate provider 110 issues the certificate generated in step 704 to service 102 or to an application platform on behalf of service 102. This enables service 102 (or the application platform on behalf of service 102) to present the certificate as a credential of service 102 to identity systems such as identity system 104 for the purposes of obtaining an access token.

### IV. Example Embodiments for Implementing Region-Based Policies

As discussed above, identity systems and/or target services such as identity system 104 and target service 106 of FIG. 1 implement region-based authentication and/or access policies. Accordingly, embodiments of identity systems condition the issuance of access tokens to services and/or target services condition the access to resources by services based at least on region information that indicates a region to which a service is assigned. In order to better illustrate some embodiments of the present disclosure, several example systems and corresponding scenarios are described below.

FIG. 8 shows an example block diagram of an example system (“system 800” hereinafter) for implementing region-based authentication and/or access policies for services in accordance with an example embodiment. As shown in FIG. 8, system 800 includes a service 802, an identity system 804, a target service 806, and a resource 808. Service 802 operates in a similar manner to service 102, identity system 804 operates in a similar manner to identity system 104, target service 806 operates in a similar manner to target service 106, and resource 808 operates in a similar manner to resource 108, as each respectively described above in reference to FIGS. 1-7. System 802 may include additional components not shown in FIG. 8 for brevity (e.g., application platforms, certificate providers, data stores, etc.).

As also shown in FIG. 8, service 802 is assigned to a first region labeled “Region A” and target service 806 and resource 808 are assigned to a second region labeled “Region B”. Identity system 804 in accordance with an embodiment is a global identity system that authenticates services across all regions in a cloud computing platform. In accordance with another embodiment, identity system 804 is a multi-region identity system that authenticates services across a subset of regions (e.g., Region A and Region B) in a cloud computing platform. Each of Region A and Region B may include additional services, target services, local identity systems, and/or resources, not shown in FIG. 8 for brevity. Furthermore, embodiments of system 800 may include any number of regions in addition to and/or in lieu of Region A and/or Region B. In view of the foregoing context, several example scenarios are described below with respect to system 800.

In a first non-limiting example scenario, service 802 transmits an access request 810 to identity system 804. Access request 810 includes a credential that includes region information that indicates that service 802 is assigned to Region A. Identity system 804 authenticates service 802 using methods described elsewhere herein and optionally determines a level of access to be provided to service 802. Identity system 804 transmits a response 812 to service 802 that includes an access token. The access token indicates service 802 is authentic. In accordance with an embodiment, the access token includes the region information. In accordance with an embodiment, the access token includes a determined level of access.

Subsequent to receiving response 812, service 802 transmits an access request 814 to target service 806, access request 814 including the access token received from identity system 804. Target service 806 evaluates the included access token in order to determine a level of access to resource 808 to grant service 802. In this first non-limiting example scenario, target service 806 determines that service 802 should have access (e.g., limited access, full access, heightened access, etc.) to resource 808 and transmits a response 816 to service 802. In accordance with an embodiment, response 816 includes resource 808 or a copy of resource 808. In accordance with another embodiment, target service 806 establishes communication between service 802 and resource 808. In this context, response 816 may indicate to service 802 that the communication is established or will be established.

In a second non-limiting example scenario, service 802 requests and receives an access token from identity system 804 as described above; however, in this second scenario, target service 806 manages access to resource 808 with respect to an access policy that limits access to resource 808 to services assigned to Region B. In this context, service 802 transmits access request 814 to target service 806, access request 814 including the access token received from identity system 804, the access token including region information that indicates service 802 is assigned to Region A. Target service 806 evaluates the access token and determines that the region information does not satisfy the access policy for providing service 802 access to resource 808. As shown in FIG. 8, target service 806 transmits response 816 to service 802. In this example scenario, response 816 indicates that access to resource 808 is denied. Response 816 optionally includes a message that indicates why access is denied (i.e., “The region service 802 is not an approved region for accessing resource 808”, or a similar message).

In a third non-limiting example scenario, Region A is a quarantined region. In this third scenario, identity system 804 receives authentication request 810 from service 802, authentication request 810 including a credential that includes region information indicating service 802 is assigned to Region A. Identity system 804 determines that service 802 is assigned to a quarantined region and denies issuance of an access token. As shown in FIG. 8, identity system 804 transmits response 812 to service 802. In this example scenario, response 812 indicates that issuance of an access token is denied. Response 812 optionally includes a message that indicates why access is denied (i.e., “Region A is a quarantined region”, or a similar message).

Several example scenarios have been described above with respect to system 800, which includes an identity system that is either a global identity system or a multi-region identity system. However, in accordance with one or more embodiments, a service authenticates with a local identity system (e.g., a regional instance of an identity system or a sub-region instance of an identity system). For example, FIG. 9 shows an example block diagram of an example system (“system 900” hereinafter) for implementing region-based access policies for services in accordance with an example embodiment. As shown in FIG. 9, system 900 includes a service 902, an identity system 904, a target service 906, and a resource 908. Service 902 operates in a similar manner to service 102, identity system 904 operates in a similar manner to identity system 104, target service 906 operates in a similar manner to target service 106, and resource 908 operates in a similar manner to resource 108, as each respectively described above in reference to FIGS. 1-7. System 902 may include additional components not shown in FIG. 9 for brevity (e.g., application platforms, certificate providers, data stores, etc.).

As also shown in FIG. 9, service 902 and identity system 904 are assigned to a first region labeled “Region A” and target service 906 and resource 908 are assigned to a second region labeled “Region B.” In the context of FIG. 9, identity system 904 is a local (e.g., regional or sub-regional) identity system that authenticates services assigned to Region A and/or sub-regions of Region A. Each of Region A and B may include additional services, target services, local identity systems, and/or resources, not shown in FIG. 9 for brevity. Furthermore, embodiments of system 900 may include any number of regions in addition to and/or in lieu of Region A and/or Region B. In view of the foregoing context, several example scenarios are described below with respect to system 900.

In a first non-limiting example scenario, service 902 transmits an access request 910 to identity system 904. Access request 910 includes a credential that includes region information that indicates that service 902 is assigned to Region A. Identity system 904 authenticates service 902 using methods described elsewhere herein and optionally determines a level of access to be provided to service 902. Identity system 904 transmits a response 912 to service 902 that includes an access token. The access token indicates service 902 is authentic. In accordance with an embodiment, the access token includes the region information. In accordance with an embodiment, the access token includes a determined level of access.

Subsequent to receiving response 912, service 902 transmits an access request 914 to target service 906, access request 914 including the access token received from identity system 804. Target service 906 evaluates the included access token in order to determine a level of access to resource 908 to grant service 902. For example, target service 906 in accordance with an embodiment evaluates region information included in and/or a determined level of access indicated by access token in order to determine a level of access to resource 908 to grant service 902. In this first non-limiting example scenario, target service 906 determines service 902 should have access (e.g., limited access, full access, heightened access, etc.) to resource 908 and transmits a response 916 to service 902. For example, in accordance with an embodiment, target service 906 manages resource 908 with respect to an access policy that indicates authenticated services assigned to Region B should be provided full access to resource 908 and authenticated services not assigned to Region A should be provided limited access to resource 908. In this context, target service 906 provides service 902 limited access to resource 908. In accordance with an embodiment, response 916 includes resource 908 or a copy of resource 908. In accordance with another embodiment, target service 906 establishes communication between service 902 and resource 908. In this context, response 916 may indicate to service 902 that the communication is established or will be established.

In a second non-limiting example scenario, service 902 requests and receives an access token from identity system 904 as described above; however, in this second scenario, target service 906 manages access to resource 908 with respect to an access policy that limits access to resource 908 to services assigned to Region B. In this context, service 902 transmits access request 914 to target service 906, access request 914 including the access token received from identity system 904, the access token including region information that indicates service 902 is assigned to Region A. Target service 906 evaluates the access token and determines that the region information does not satisfy the access policy for providing service 902 access to resource 908. As shown in FIG. 9, target service 906 transmits response 916 to service 902. In this example scenario, response 916 indicates that access to resource 908 is denied. Response 916 optionally includes a message that indicates why access is denied (i.e., “The region service 902 is not an approved region for accessing resource 908”, or a similar message).

In a third non-limiting example scenario, Region A is a quarantined region. In this third scenario, service 902 requests and receives an access token from identity system 904 as described above. Service 902 transmits access request 914 to target service 906, access request 914 including the access token received from identity system 904, the access token including region information that indicates service 902 is assigned to Region A. Target service 906 evaluates the access token, determines that the region service 902 is assigned to is a quarantined region, and denies access to resource 908. As shown in FIG. 9, target service 906 transmits response 916 to service 902. In this example scenario, response 916 indicates that access to resource 908 is denied. Response 916 optionally includes a message that indicates why access is denied (i.e., “Region A is a quarantined region”, or a similar message).

Thus, several example embodiments and scenarios for implementing region-based authentication and/or access policies have been described above with respect to system 800 of FIG. 8 and system 900 of FIG. 9. It should also be understood that similar systems may be used for implementing other region-based authentication and/or access policies, as described elsewhere herein. Furthermore, while the above scenarios have been described with respect to identity systems that receive a credential that includes region information and target services that receive an access token that includes region information, it is also contemplated herein that region information may not be included in a credential and/or access token. In this context, identity systems and/or target services determine the region a service is assigned to in other ways. For instance, as will be discussed in the following section, an identity system in accordance with an embodiment obtains region information that is stored in association with an identifier of the service.

### V. Example Embodiments for Obtaining Region Information

As discussed above embodiments of identity systems implement region-based authentication and/or access policies in order to determine if an access token should be issued to a service and/or generate access tokens to be issued to a service. System 100 of FIG. 1 has been described with respect to FIGS. 2 and 3, where an authentication request includes a credential that includes region information that indicates a region to which service 102 is assigned, and with respect to FIG. 5, where an access token includes such region information. However, region information that indicates the region to which service 102 is assigned may be determined and/or identified in other ways, in one or more alternative embodiments. For instance, region information associated with service 102 in accordance with one or more alternative embodiments is stored as region information 130 in data store 128. In this context, identity system 104 and/or target service 106 obtain region information associated with service 120 from data store 128 to perform various authentications and/or access determinations, as will be described further below with respect to FIGS. 10-12.

Identity system 104 in accordance with one or more embodiments obtains region information associated with service 102 to authenticate service 102. For example, FIG. 10 shows a flowchart 1000 of a process for providing an access token that includes region information in accordance with an example embodiment. In accordance with an embodiment, identity system 104 of FIG. 1 operates according to flowchart 1000. Not all steps of flowchart 1000 need be performed in all embodiments. Further structural and operational embodiments will be apparent to persons skilled in the relevant art(s) based on the following description of FIG. 10.

Flowchart 1000 begins with step 1002. In step 1002, an authentication request is received from a service. For example, identity system 104 of FIG. 1 receives an authentication request from service 102. In this context, the authentication request includes a credential associated with service 102. The credential is any type of credential associated with service 102 that service 102 (or an application platform on behalf of service 102) presents to identity system 104 for the purpose of determining an authenticity of service 102, as described elsewhere herein.

In step 1004, region information that is stored in association with an identifier of the service is obtained. The region information indicates a region to which the service is assigned. For example, service authenticator 122 of FIG. 1 obtains region information stored in association with an identifier of service 102 as region information 130 in data store 128. In accordance with an embodiment, the identifier of service 102 is included in the authentication request received in step 1002. In accordance with another embodiment, service authenticator 122 determines the identifier of service 102 based on the authentication request received in step 1002. Examples of identifiers of service 102 include, but are not limited to, an application key issued to service 102, a certificate issued to service 102, a certificate issued to the service on behalf of service 102, a device identifier corresponding to a hardware authentication device associated with service 102, and/or any other identifier suitable for identifying service 102. In accordance with an embodiment, region information 130 is stored in a table that maps region information 130 to the identifier of service 102.

Steps 1006 and 1008 are performed in similar respective manners to steps 204 and 206 of flowchart 200, as described above with respect to FIG. 2 and therefore are not described further herein for the sake of brevity.

Identity system 104 in accordance with one or more embodiments obtains region information associated with service 102 to determine a level of access to provide to service 102. For example, FIG. 11 shows a flowchart 1100 of a process for providing an access token that indicates a level of access in accordance with an example embodiment. In accordance with an embodiment, identity system 104 of FIG. 1 operates according to flowchart 1100. Not all steps of flowchart 1100 need be performed in all embodiments. Further structural and operational embodiments will be apparent to persons skilled in the relevant art(s) based on the following description of FIG. 11.

Flowchart 1100 begins with step 1102. In step 1102, an authentication request is received from a service. For example, identity system 104 of FIG. 1 receives an authentication request from service 102. In this context, the authentication request includes a credential associated with service 102. The credential is any type of credential associated with service 102 that service 102 (or an application platform on behalf of service 102) presents to identity system 104 for the purpose of determining an authenticity of service 102, as described elsewhere herein.

In step 1104, region information that is stored in association with an identifier of the service is obtained. The region information indicates a region to which the service is assigned. For example, service authenticator 122 of FIG. 1 obtains region information stored in association with an identifier of service 102 as region information 130 in data store 128. In accordance with an embodiment, the identifier of service 102 is included in the authentication request received in step 1102. In accordance with another embodiment, service authenticator 122 determines the identifier of service 102 based on the authentication request received in step 1102. The identifier of service 102 is any type of identifier suitable for identifying service 102, as described elsewhere herein. In accordance with an embodiment, region information 130 is stored in a table that maps region information 130 to the identifier of service 102.

Steps 1106-1112 are performed in similar respective manners as steps 304-310 of flowchart 300, as described above with respect to FIG. 3 and therefore are not described further herein for the sake of brevity.

Steps of flowchart 1100 may be performed in a different order than that shown in FIG. 11. For instance, while FIG. 11 depicts the authentication of step 1110 being performed subsequent to the determinations made in steps 1106 and 1108, it is also contemplated herein that the authentication of step 1110 may be performed prior to step 1106 and/or 1108. For example, access determiner 124 in accordance with an embodiment performs step 1106 and/or step 1108 subsequent to service authenticator 122 having authenticated service 102 based on the credential.

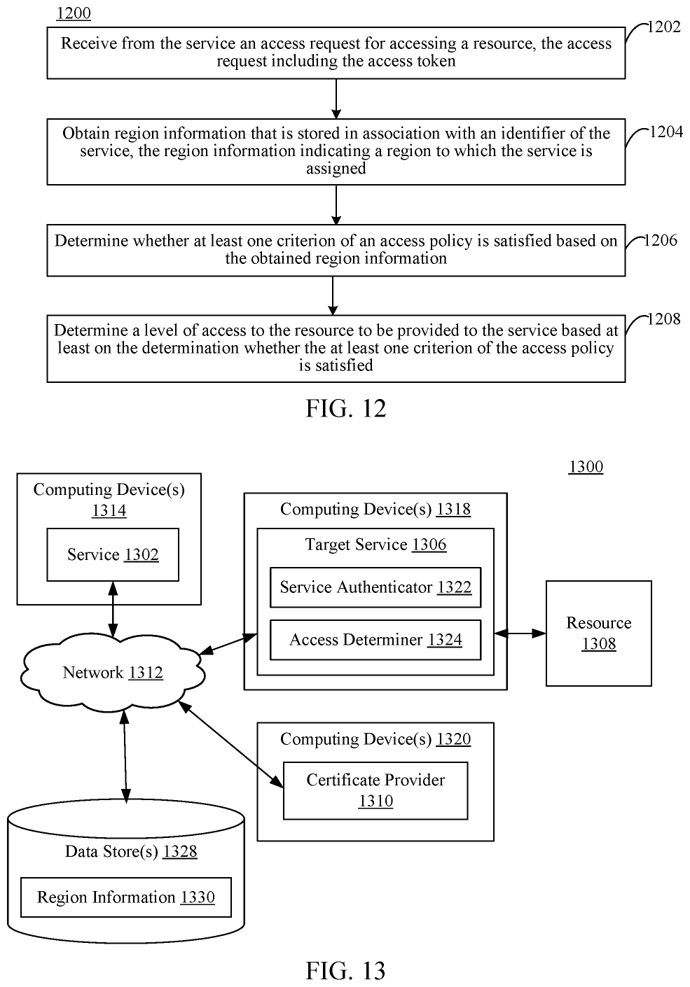

Target service 106 in accordance with one or more embodiments obtains region information associated with service 102 to determine a level of access to provide to service 102. For example, FIG. 12 shows a flowchart 1200 of a process for determining a level of access to a resource in accordance with an example embodiment. In accordance with an embodiment, target service 106 of FIG. 1 operates according to flowchart 1200. Not all steps of flowchart 1200 need be performed in all embodiments. Further structural and operational embodiments will be apparent to persons skilled in the relevant art(s) based on the following description of FIG. 12.

Flowchart 1200 begins with step 1202. In step 1202, an access request for accessing a resource is received from a service. The access request includes an access token. For example, target service 106 of FIG. 1 receives an access request for accessing resource 108 from service 102, the access request including an access token (e.g., an access token issued by identity system 104). In accordance with an embodiment, the access token includes a level of access determined by identity system 104 (e.g., as described above with respect to flowchart 300 of FIG. 3 and/or flowchart 1100 of FIG. 11).

In step 1204, region information that is stored in association with an identifier of the service is obtained. The region information indicates a region to which the service is assigned. For example, target service 106 of FIG. 1 obtains region information stored in association with an identifier of service 102 as region information 130 in data store 128. In accordance with an embodiment, the identifier of service 102 is included in the access request received in step 1202. In accordance with another embodiment, target service 106 determines the identifier of service 102 based on the access request received in step 1202. The identifier of service 102 is any type of identifier suitable for identifying service 102, as described elsewhere herein. In accordance with an embodiment, region information 130 is stored in a table that maps region information 130 to the identifier of service 102.

In step 1206, a determination of whether at least one criterion of an access policy is satisfied is made based on the obtained region information. For example, target service 106 of FIG. 1 determines whether at least one criterion of an access policy is satisfied made based on the region information obtained in step 1204. In accordance with an embodiment, target service 106 access policy information stored by target service 106, policy information stored by computing devices 118, and/or policy information otherwise accessible to target service 106 to verify that the obtained region information satisfies at least one criterion of an access policy. Examples of access policies include, but are not limited to, conditional access policies and RBAC policies. In accordance with an embodiment, target service evaluates the obtained region information against at least one criterion of multiple access policies to determine if each of the respective criterion are satisfied. Example criterion of an access policy include, but are not limited to, whether a region to which service 102 is assigned to is a quarantined region, whether the region to which the service is assigned to is a region that is allowed access to resource 108, whether a risk level associated with the region to which the service is a risk level accepted by the access policy, and/or any other criterion that target service 106 may evaluate the region information included in the access token against.

Step 1208 is performed in similar respective manners as step 506 of flowchart 500, as described above with respect to FIG. 5 and therefore is not described further herein for the sake of brevity.

### VI. Further Example Embodiments

A. Authenticating by Target Services

Embodiments have been described herein with respect to services authenticating with identity systems. However, in accordance with one or more embodiments, services are authenticated by a target service. For example, FIG. 13 shows an example block diagram of an example system 1300 (“system 1300” hereinafter) for implementing region-based authentication and/or access policies for services in accordance with an example embodiment. As shown in FIG. 13, system 1300 includes one or more computing device(s) 1314 (“computing devices 1314” hereinafter), one or more computing device(s) 1318 (“computing devices 118” hereinafter), one or more computing device(s) 1320 (“computing devices 1320” hereinafter), resource 1308 and one or more data store(s) 1328 (“data store 1328” hereinafter). Computing devices 1314, computing devices 1320, resource 1308, and data store 1328 are examples of computing devices 114, computing devices 120, resource 108, and data store 128, as described above with respect to system 100 of FIG. 1. Computing devices 118 is one or more of any type of computing device, as described elsewhere herein. In embodiments, computing devices 1314, 1318, and/or 1320, resource 1308, and/or data store 1328 are communicatively coupled via one or more networks 1312, which is an example of network 112 as described above with respect to system 100 of FIG. 1.

As shown in FIG. 13, computing devices 1314 include a service 1302, computing devices 1318 include a target service 1306, and computing devices 1320 include a certificate provider 1310. Service 1302 and certificate provider 1310 operate in a similar manner to service 102 and certificate provider 110 of system 100 of FIG. 1.

Target service 1306 operates in a similar manner to target service 1306 of system 100, as described above with respect to FIG. 1 and further operates in a manner similar to identity system 104 of system 100 in order to authenticate services (e.g., service 1302) and determine levels of access to be provided to services (e.g., service 1302). For example, as shown in FIG. 13, target service 1306 includes a service authenticator 1322 and an access determiner 1324. Service authenticator 1322 authenticates services (e.g., service 1302) in a similar manner to service authenticator 122 of system 100 as described above with respect to FIG. 1. For instance, service authenticator 1322 may perform operations similar to those described above with respect to service authenticator 122, including, but not limited to, any of steps 202 and/or steps 204 of flowchart 200, as described above with respect to FIG. 2, steps 302 and/or 304 of flowchart 300, as described above with respect to FIG. 3, steps 404-408 of flowchart 400, as described above with respect to FIG. 4, steps 1002-1006 of flowchart 1000, as described above with respect to FIG. 10, and/or steps 1102, 1104, and/or 1110 of flowchart 1100, as described above with respect to FIG. 11. For example, service authenticator 1322 in accordance with an embodiment determines whether or not to authenticate service 1302 based at least on an identifier associated with service 1302, a credential associated with service 1302, region information of service 1302, region information stored in association with an identifier of service 1302, a level of access provided to service 1302, and/or any other information associated with service 1302 suitable for authenticating service 1302, as described elsewhere herein. Service authenticator 1322 in accordance with an embodiment determines whether or not to authenticate service 1302 based on an authentication policy. Authentication policies may be stored in an external storage accessible to service authenticator 1314 (e.g., such as data store 1328) and/or stored locally by service authenticator 1322 or target service 1306.

Access determiner 1324 determines a level of access a service (e.g., service 1302) should have to resource 1308 (and/or other resources managed by target service 1306, not shown in FIG. 13). Example levels of access to a resource include, but are not limited to, no access, limited access, full access, and/or heightened access. In accordance with an embodiment, access determiner 1324 determines a level of access to resource 1308 to be provided to service 1302 prior to service authenticator 1322 authenticating service 1302. In accordance with another embodiment, access determiner 1324 determines a level of access to be provided to the service subsequent to service authenticator 1322 authenticating service 1302. In accordance with an embodiment, access determiner 1324 performs one or more operations similar to those performed by access determiner 124 of FIG. 1 (e.g., steps 304 and/or 306 of flowchart 300, as described above with respect to FIG. 3, and/or steps 1104-1108 of flowchart 1100, as described above with respect to FIG. 11). In accordance with another embodiment, access determiner 1324 performs one or more operations similar to those performed by target service 106 of FIG. 1 (e.g., steps 504 and/or 506 of flowchart 500, as described above with respect to FIG. 5, step 604 of flowchart 600, as described above with respect to FIG. 6, and/or steps 1204-1208 of flowchart 1200, as described above with respect to FIG. 12).

In accordance with one or more embodiments, service 1302 of FIG. 13 requests access to resource 1308. In order to obtain access, service 1302 transmits an access request to target service 1306 that includes a credential that includes region information that indicates a region that service 1302 is assigned to. In this context, target service 1306 determines an authenticity of service 1302 and/or a level of access to resource 1308 to be provided to service 1302.

B. Identity System Region Information

Several example embodiments have been described herein with respect to services assigned to a region and authenticating and/or determining a level of access to be provided to the services based at least on the assigned region. In accordance with one or more embodiments, the identity system that authenticates the service is also assigned to a region. In this context, the identity system is configured to include identity system region information in access tokens provided to an authenticated service. The identity system region information indicates a region the identity system is assigned to. In accordance with an embodiment, the identity system embeds the region information in the access token. By doing so, a target service is able to determine a level of access to a resource to be provided to a service based at least on the region that the authenticating identity system is assigned to. For example, if an identity system assigned to a region is compromised by a malicious entity, a target service in accordance with an embodiment determines a “no access” level of access to a resource is to be provided to services authenticated by the compromised identity system.

In accordance with another embodiment, the identity system signs the access token with a private signing key of a signing key pair associated with the assigned region. In this context, a target service in accordance with an embodiment determines to provide a service with a level of access to a resource based on the signature of the access token. For example, a target service in accordance with an embodiment manages a resource based on an access policy that indicates which signatures are acceptable signatures for verifying access tokens. If a cloud computing platform determines that a region should no longer have access to resources managed by the target service (e.g., the region is a quarantined region), the access policy is updated to remove the signature of the identity system assigned to the quarantined region from the acceptable signatures. By assigning unique signing keys to instances of identity systems in each region, systems described herein are able to dynamically update and enforce region-based access policies for determining levels of access to resources.

### VII. Example Computing Device Implementation

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

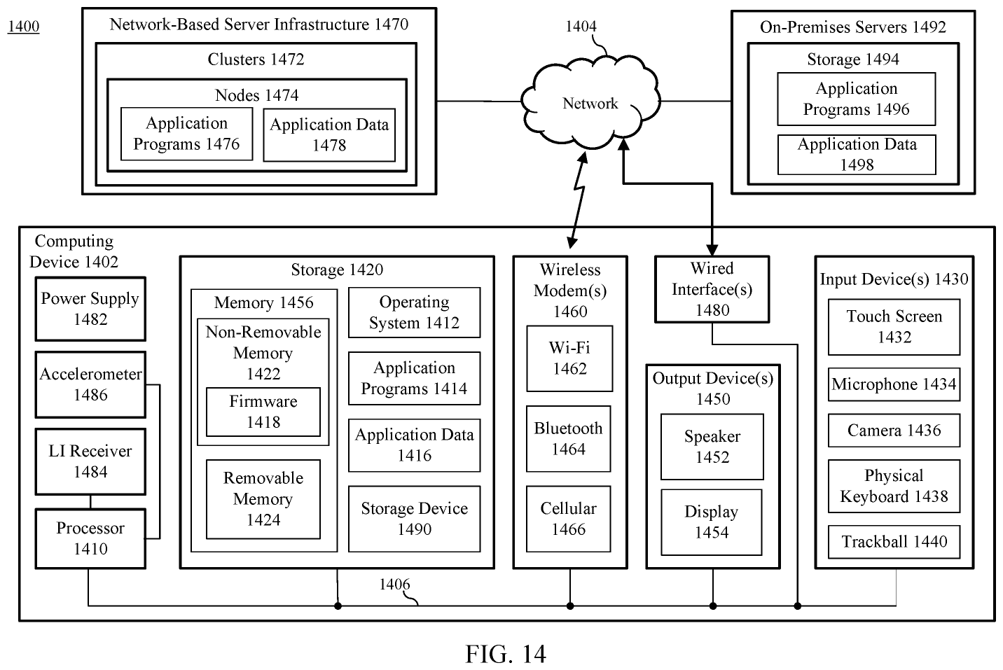

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 14. FIG. 14 shows a block diagram of an exemplary computing environment 1400 that includes a computing device 1402. Computing device 1402 is an example of computing devices 114, computing devices 116, computing devices 118, and computing devices 120 of FIG. 1 and/or computing devices 1314, computing devices 1318, and computing devices 1320 of FIG. 13, each of which may include one or more of the components of computing device 1402. In some embodiments, computing device 1402 is communicatively coupled with devices (not shown in FIG. 14) external to computing environment 1400 via network 1404. Network 1404 is an example of network 112 of FIG. 1 or network 1312 of FIG. 13, and comprises one or more networks such as local area networks (LANs), wide area networks (WANs), enterprise networks, the Internet, etc., and may include one or more wired and/or wireless portions. Network 1404 may additionally or alternatively include a cellular network for cellular communications. Computing device 1402 is described in detail as follows

Computing device 1402 can be any of a variety of types of computing devices. For example, computing device 1402 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 1402 may alternatively be a stationary computing device such as a desktop computer, a personal computer (PC), a stationary server device, a minicomputer, a mainframe, a supercomputer, etc.

As shown in FIG. 14, computing device 1402 includes a variety of hardware and software components, including a processor 1410, a storage 1420, one or more input devices 1430, one or more output devices 1450, one or more wireless modems 1460, one or more wired interfaces 1480, a power supply 1482, a location information (LI) receiver 1484, and an accelerometer 1486. Storage 1420 includes memory 1456, which includes non-removable memory 1422 and removable memory 1424, and a storage device 1490. Storage 1420 also stores an operating system 1412, application programs 1414, and application data 1416. Wireless modem(s) 1460 include a Wi-Fi modem 1462, a Bluetooth modem 1464, and a cellular modem 1466. Output device(s) 1450 includes a speaker 1452 and a display 1454. Input device(s) 1430 includes a touch screen 1432, a microphone 1434, a camera 1436, a physical keyboard 1438, and a trackball 1440. Not all components of computing device 1402 shown in FIG. 14 are present in all embodiments, additional components not shown may be present, and any combination of the components may be present in a particular embodiment. These components of computing device 1402 are described as follows.

A single processor 1410 (e.g., central processing unit (CPU), microcontroller, a microprocessor, signal processor, ASIC (application specific integrated circuit), and/or other physical hardware processor circuit) or multiple processors 1410 may be present in computing device 1402 for performing such tasks as program execution, signal coding, data processing, input/output processing, power control, and/or other functions. Processor 1410 may be a single-core or multi-core processor, and each processor core may be single-threaded or multithreaded (to provide multiple threads of execution concurrently). Processor 1410 is configured to execute program code stored in a computer readable medium, such as program code of operating system 1412 and application programs 1414 stored in storage 1420. Operating system 1412 controls the allocation and usage of the components of computing device 1402 and provides support for one or more application programs 1414 (also referred to as “applications” or “apps”). Application programs 1414 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1402 can communicate with any other component according to function, although not all connections are shown for ease of illustration. For instance, as shown in FIG. 14, bus 1406 is a multiple signal line communication medium (e.g., conductive traces in silicon, metal traces along a motherboard, wires, etc.) that may be present to communicatively couple processor 1410 to various other components of computing device 1402, although in other embodiments, an alternative bus, further buses, and/or one or more individual signal lines may be present to communicatively couple components. Bus 1406 represents one or more of any of several types of bus structures, including a memory bus or memory controller, a peripheral bus, an accelerated graphics port, and a processor or local bus using any of a variety of bus architectures.

Storage 1420 is physical storage that includes one or both of memory 1456 and storage device 1490, which store operating system 1412, application programs 1414, and application data 1416 according to any distribution. Non-removable memory 1422 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1422 may include main memory and may be separate from or fabricated in a same integrated circuit as processor 1410. As shown in FIG. 14, non-removable memory 1422 stores firmware 1418, which may be present to provide low-level control of hardware. Examples of firmware 1418 include BIOS (Basic Input/Output System, such as on personal computers) and boot firmware (e.g., on smart phones). Removable memory 1424 may be inserted into a receptacle of or otherwise coupled to computing device 1402 and can be removed by a user from computing device 1402. Removable memory 1424 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1490 may be present that are internal and/or external to a housing of computing device 1402 and may or may not be removable. Examples of storage device 1490 include a hard disk drive, a SSD, a thumb drive (e.g., a USB (Universal Serial Bus) flash drive), or other physical storage device.

One or more programs may be stored in storage 1420. Such programs include operating system 1412, one or more application programs 1414, and other program modules and program data. Examples of such application programs may include, for example, computer program logic (e.g., computer program code/instructions) for implementing one or more of service 102, identity system 104, target service 106, resource 108, certificate provider 110, service authenticator 122, access determiner 124, access token generator 126, service 802, identity system 804, target service 806, resource 808, service 902, identity system 904, target service 906, resource 908, service 1302, target service 1306, resource 1308, certificate provider 1310, service authenticator 1322, access determiner 1324, along with any components and/or subcomponents thereof, as well as the flowcharts/flow diagrams (e.g., flowcharts 200, 300, 400, 500, 600, 700, 1000, 1100, and/or 1200) described herein, including portions thereof, and/or further examples described herein.

Storage 1420 also stores data used and/or generated by operating system 1412 and application programs 1414 as application data 1416. Examples of application data 1416 include web pages, text, images, tables, sound files, video data, and other data, which may also be sent to and/or received from one or more network servers or other devices via one or more wired or wireless networks. Storage 1420 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1402 through one or more input devices 1430 and may receive information from computing device 1402 through one or more output devices 1450. Input device(s) 1430 may include one or more of touch screen 1432, microphone 1434, camera 1436, physical keyboard 1438 and/or trackball 1440 and output device(s) 1450 may include one or more of speaker 1452 and display 1454. Each of input device(s) 1430 and output device(s) 1450 may be integral to computing device 1402 (e.g., built into a housing of computing device 1402) or external to computing device 1402 (e.g., communicatively coupled wired or wirelessly to computing device 1402 via wired interface(s) 1480 and/or wireless modem(s) 1460). Further input devices 1430 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1454 may display information, as well as operating as touch screen 1432 by receiving user commands and/or other information (e.g., by touch, finger gestures, virtual keyboard, etc.) as a user interface. Any number of each type of input device(s) 1430 and output device(s) 1450 may be present, including multiple microphones 1434, multiple cameras 1436, multiple speakers 1452, and/or multiple displays 1454.

One or more wireless modems 1460 can be coupled to antenna(s) (not shown) of computing device 1402 and can support two-way communications between processor 1410 and devices external to computing device 1402 through network 1404, as would be understood to persons skilled in the relevant art(s). Wireless modem 1460 is shown generically and can include a cellular modem 1466 for communicating with one or more cellular networks, such as a GSM network for data and voice communications within a single cellular network, between cellular networks, or between the mobile device and a public switched telephone network (PSTN). Wireless modem 1460 may also or alternatively include other radio-based modem types, such as a Bluetooth modem 1464 (also referred to as a “Bluetooth device”) and/or Wi-Fi 1462 modem (also referred to as an “wireless adaptor”). Wi-Fi modem 1462 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1464 is configured to communicate with another Bluetooth-capable device according to the Bluetooth short-range wireless technology standard(s) such as IEEE 802.15.1 and/or managed by the Bluetooth Special Interest Group (SIG).

Computing device 1402 can further include power supply 1482, LI receiver 1484, accelerometer 1486, and/or one or more wired interfaces 1480. Example wired interfaces 1480 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1480 of computing device 1402 provide for wired connections between computing device 1402 and network 1404, or between computing device 1402 and one or more devices/peripherals when such devices/peripherals are external to computing device 1402 (e.g., a pointing device, display 1454, speaker 1452, camera 1436, physical keyboard 1438, etc.). Power supply 1482 is configured to supply power to each of the components of computing device 1402 and may receive power from a battery internal to computing device 1402, and/or from a power cord plugged into a power port of computing device 1402 (e.g., a USB port, an A/C power port). LI receiver 1484 may be used for location determination of computing device 1402 and may include a satellite navigation receiver such as a Global Positioning System (GPS) receiver or may include other type of location determiner configured to determine location of computing device 1402 based on received information (e.g., using cell tower triangulation, etc.). Accelerometer 1486 may be present to determine an orientation of computing device 1402.

Note that the illustrated components of computing device 1402 are not required or all-inclusive, and fewer or greater numbers of components may be present as would be recognized by one skilled in the art. For example, computing device 1402 may also include one or more of a gyroscope, barometer, proximity sensor, ambient light sensor, digital compass, etc. Processor 1410 and memory 1456 may be co-located in a same semiconductor device package, such as being included together in an integrated circuit chip, FPGA, or system-on-chip (SOC), optionally along with further components of computing device 1402.

In embodiments, computing device 1402 is configured to implement any of the above-described features of flowcharts herein. Computer program logic for performing any of the operations, steps, and/or functions described herein may be stored in storage 1420 and executed by processor 1410.

In some embodiments, server infrastructure 1470 may be present in computing environment 1400 and may be communicatively coupled with computing device 1402 via network 1404. Server infrastructure 1470, when present, may be a network-accessible server set (e.g., a cloud computing platform). As shown in FIG. 14, server infrastructure 1470 includes clusters 1472. Each of clusters 1472 may comprise a group of one or more compute nodes and/or a group of one or more storage nodes. For example, as shown in FIG. 14, cluster 1472 includes nodes 1474. Each of nodes 1474 are accessible via network 1404 (e.g., in a “cloud computing platform” or “cloud-based” embodiment) to build, deploy, and manage applications and services. Any of nodes 1474 may be a storage node that comprises a plurality of physical storage disks, SSDs, and/or other physical storage devices that are accessible via network 1404 and are configured to store data associated with the applications and services managed by nodes 1474. For example, as shown in FIG. 14, nodes 1474 may store application data 1478.

Each of nodes 1474 may, as a compute node, comprise one or more server computers, server systems, and/or computing devices. For instance, a node 1474 may include one or more of the components of computing device 1402 disclosed herein. Each of nodes 1474 may be configured to execute one or more software applications (or “applications”) and/or services and/or manage hardware resources (e.g., processors, memory, etc.), which may be utilized by users (e.g., customers) of the network-accessible server set. For example, as shown in FIG. 14, nodes 1474 may operate application programs 1476. In an implementation, a node of nodes 1474 may operate or comprise one or more virtual machines, with each virtual machine emulating a system architecture (e.g., an operating system), in an isolated manner, upon which applications such as application programs 1476 may be executed.

In an embodiment, one or more of clusters 1472 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1472 may be a datacenter in a distributed collection of datacenters. In embodiments, exemplary computing environment 1400 comprises part of a cloud-based platform such as Amazon Web Services® of Amazon Web Services, Inc. or Google Cloud Platform™ of Google LLC, although these are only examples and are not intended to be limiting.

In an embodiment, computing device 1402 may access application programs 1476 for execution in any manner, such as by a client application and/or a browser at computing device 1402. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1402 may additionally and/or alternatively synchronize copies of application programs 1414 and/or application data 1416 to be stored at network-based server infrastructure 1470 as application programs 1476 and/or application data 1478. For instance, operating system 1412 and/or application programs 1414 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1420 at network-based server infrastructure 1470.

In some embodiments, on-premises servers 1492 may be present in computing environment 1400 and may be communicatively coupled with computing device 1402 via network 1404. On-premises servers 1492, when present, are hosted within an organization's infrastructure and, in many cases, physically onsite of a facility of that organization. On-premises servers 1492 are controlled, administered, and maintained by IT (Information Technology) personnel of the organization or an IT partner to the organization. Application data 1498 may be shared by on-premises servers 1492 between computing devices of the organization, including computing device 1402 (when part of an organization) through a local network of the organization, and/or through further networks accessible to the organization (including the Internet). Furthermore, on-premises servers 1492 may serve applications such as application programs 1496 to the computing devices of the organization, including computing device 1402. Accordingly, on-premises servers 1492 may include storage 1494 (which includes one or more physical storage devices such as storage disks and/or SSDs) for storage of application programs 1496 and application data 1498 and may include one or more processors for execution of application programs 1496. Still further, computing device 1402 may be configured to synchronize copies of application programs 1414 and/or application data 1416 for backup storage at on-premises servers 1492 as application programs 1496 and/or application data 1498.

Embodiments described herein may be implemented in one or more of computing device 1402, network-based server infrastructure 1470, and on-premises servers 1492. For example, in some embodiments, computing device 1402 may be used to implement systems, clients, or devices, or components/subcomponents thereof, disclosed elsewhere herein. In other embodiments, a combination of computing device 1402, network-based server infrastructure 1470, and/or on-premises servers 1492 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1420. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1414) may be stored in storage 1420. Such computer programs may also be received via wired interface(s) 1480 and/or wireless modem(s) 1460 over network 1404. Such computer programs, when executed or loaded by an application, enable computing device 1402 to implement features of embodiments discussed herein. Accordingly, such computer programs represent controllers of the computing device 1402.

Embodiments are also directed to computer program products comprising computer code or instructions stored on any computer-readable medium or computer-readable storage medium. Such computer program products include the physical storage of storage 1420 as well as further physical storage types.

### VIII. Additional Example Embodiments

A system is described herein. The system includes an identity system implemented by one or more first computing devices. The identity system receives an authentication request from a service. The authentication request includes a credential associated with the service. The credential includes region information that indicates a region to which the service is assigned. The identity system authenticates the service based on the credential. The identity system provides an access token to the service that includes the region information.

In one implementation of the foregoing system, the credential is: an identity token that was provided to the service by an application platform based on a prior authentication of the application platform by the identity system; an application key; a certificate issued to the service or to an application platform on behalf of the service; an identifier associated with the service; or a device identifier corresponding to a hardware authentication device associated with the service, or a value derived therefrom.

In one implementation of the foregoing system, the credential is the certificate. The system further includes a certificate provider implemented by one or more second computing devices. The certificate provider determines the region information based on the region the service is assigned to. The certificate provider generates the certificate that includes the region information. The certificate provider issues the certificate to the service.

In one implementation of the foregoing system, the certificate provider is a certificate authority.

In one implementation of the foregoing system, the identity system authenticates the service by: determining that at least one criterion of an authentication policy is satisfied based on the region information; and authenticating the service based at least on the determination.

In one implementation of the foregoing system, said determining that the at least one criterion of the authentication policy is satisfied based on the region information includes determining that the region to which the service is assigned is not a quarantined region.

In one implementation of the foregoing system, said determining that the at least one criterion of the authentication policy is satisfied based on the region information includes determining that a risk level associated with the region to which the service is assigned does satisfy a criterion of the authentication policy.

In one implementation of the foregoing system, said determining that the at least one criterion of the authentication policy is satisfied based on the region information includes determining that the region to which the service is assigned is a region that is allowed authentication.

In one implementation of the foregoing system, the system further includes a target service implemented by one or more second computing devices. The target service receives from the service an access request for accessing a resource. The access request includes the access token. The target service determines whether at least one criterion of an access policy is satisfied based on the region information included in the access token. The target service determines a level of access to the resource to be provided to the service based at least on the determination whether the at least one criterion of the access policy is satisfied.

In one implementation of the foregoing system, the determined level of access to the resource includes one of: no access to the resource; limited access to the resource; or full access to the resource.

In one implementation of the foregoing system, the access policy is: a conditional access policy or a role-based access control policy.

In one implementation of the foregoing system, said determining that the at least one criterion of the access policy is satisfied based on the region information includes determining that the region to which the service is assigned is not a quarantined region.

In one implementation of the foregoing system, said determining that the at least one criterion of the access policy is satisfied based on the region information includes determining that a risk level associated with the region to which the service is assigned does satisfy a criterion of the access policy.

In one implementation of the foregoing system, said determining that the at least one criterion of the access policy is satisfied based on the region information includes determining that the region to which the service is assigned is a region that is allowed access to the resource.

A method is also disclosed herein. The method includes performing by an identity system implemented by one or more first computing devices: receiving an authentication request from a service, the authentication request including a credential associated with the service, the credential including region information that indicates a region to which the service is assigned; determining whether at least one criterion of an access policy is satisfied based on the region information included in the credential; determining a level of access to be provided to the service based at least on the determination whether the at least one criterion of the access policy is satisfied; authenticating the service based on the credential; and generating an access token that indicates that the service is authenticated and the determined level of access.

In one implementation of the foregoing method, the determined level of access to be provided to the service includes one of: no access; limited access; or full access.

In one implementation of the foregoing method, the access policy is: a conditional access policy or a role-based access control policy.

In one implementation of the foregoing method, the credential is: an identity token that was provided to the service by an application platform based on a prior authentication of the application platform by the identity system; an application key; a certificate issued to the service or to an application platform on behalf of the service; an identifier associated with the service; or a device identifier corresponding to a hardware authentication device associated with the service, or a value derived therefrom.

In one implementation of the foregoing method, the credential is the certificate. The method further includes performing by a certificate provider implemented by one or more second computing devices: determining the region information based on the region to which the service is assigned; generating the certificate that includes the region information; and issuing the certificate to the service or to the application platform on behalf of the service.

In one implementation of the foregoing method, said authenticating the service based on the credential includes: determining that at least one criterion of an authentication policy is satisfied based at least on the region information; and authenticating the service based at least on the determination that the at least one criterion of the authentication policy is satisfied.

In one implementation of the foregoing method, said determining that at least one criterion of the authentication policy is satisfied based on the region information included in the credential includes: determining that the region to which the service is assigned is not a quarantined region; determining that the region to which the service is assigned is a region that is allowed authentication; or determining that a risk level associated with the region to which the service is assigned satisfies a criterion of the authentication policy.

In one implementation of the foregoing method, said determining whether at least one criterion of the access policy is satisfied based on the region information included in the credential includes: determining whether the region to which the service is assigned is a quarantined region; determining whether the region to which the service is assigned is a region that is allowed access; or determining whether a risk level associated with the region to which the service is assigned satisfies a criterion of the access policy.

In one implementation of the foregoing method, the method further includes performing by a target service implemented by one or more second computing devices: receiving from the service an access request for accessing a resource, the access request including the access token; and determining a level of access to the resource based at least on the level of access indicated by the access token.

A computer-readable storage medium is described herein. The computer-readable storage medium has computer program logic recorded thereon that when executed by at least one processor of an identity system causes the at least one processor to perform a method. The method includes: receiving an authentication request from a service, the authentication request including a credential associated with the service, the credential including region information that indicates a region to which the service is assigned; determining that at least one criterion of an authentication policy is not satisfied based on the region information; and denying issuance of an access token to the service based on the determination.

In one implementation of the foregoing computer-readable storage medium, the credential is: an identity token that was provided to the service by an application platform based on a prior authentication of the application platform by the identity system; an application key; a certificate issued to the service or to an application platform on behalf of the service; an identifier associated with the service; or a device identifier corresponding to a hardware authentication device associated with the service, or a value derived therefrom.

In one implementation of the foregoing computer-readable storage medium, said determining that the at least one criterion of the authentication policy is not satisfied based on the region information includes determining that the region to which the service is assigned is a quarantined region.

In one implementation of the foregoing computer-readable storage medium, said determining that the at least one criterion of the authentication policy is not satisfied based on the region information includes determining that a risk level associated with the region to which the service is assigned does not satisfy a criterion of the authentication policy.

In one implementation of the foregoing computer-readable storage medium, said determining that the at least one criterion of the authentication policy is not satisfied based on the region information includes determining that the region to which the service is assigned is not a region that is allowed authentication.

A system is described herein. The system includes an identity system implemented by one or more first computing devices. The identity system receives an authentication request from a service. The identity system obtains region information that is stored in association with an identifier of the service. The region information indicates a region to which the service is assigned. The identity system authenticates the service. The identity system provides an access token to the service that includes the region information.

In one implementation of the foregoing system, the identifier of the service is: an application key issued to the service; a certificate issued to the service or to an application on behalf of the service; or a device identifier corresponding to a hardware authentication device associated with the service.

In one implementation of the foregoing system, the identity system authenticates the service by: determining that at least one criterion of an authentication policy is satisfied based on the region information; and authenticating the service based at least on the determination.

In one implementation of the foregoing system, said determining that the at least one criterion of the authentication policy is satisfied based on the region information includes determining that the region to which the service is assigned is not a quarantined region.

In one implementation of the foregoing system, said determining that the at least one criterion of the authentication policy is satisfied based on the region information includes determining that a risk level associated with the region to which the service is assigned does satisfy a criterion of the authentication policy.

In one implementation of the foregoing system, said determining that the at least one criterion of the authentication policy is satisfied based on the region information includes determining that the region to which the service is assigned is a region that is allowed authentication.

In one implementation of the foregoing system, the system further includes a target service implemented by one or more second computing devices. The target service receives from the service an access request for accessing a resource. The access request including the access token. The target service determines whether at least one criterion of an access policy is satisfied based on the region information included in the access token. The target service determines a level of access to the resource to be provided to the service based at least on the determination whether the at least one criterion of the access policy is satisfied.

In one implementation of the foregoing system, the determined level of access to the resource includes one of: no access to the resource; limited access to the resource; or full access to the resource.

In one implementation of the foregoing system, the access policy is: a conditional access policy; or a role-based access control policy.

In one implementation of the foregoing system, said determining that the at least one criterion of the access policy is satisfied based on the region information includes determining that the region to which the service is assigned is not a quarantined region.

In one implementation of the foregoing system, said determining that the at least one criterion of the access policy is satisfied based on the region information includes determining that a risk level associated with the region to which the service is assigned does satisfy a criterion of the access policy.

In one implementation of the foregoing system, said determining that the at least one criterion of the access policy is satisfied based on the region information includes determining that the region to which the service is assigned is a region that is allowed access to the resource.

In one implementation of the foregoing system, the identity system stores the region information in association with the identifier of the service.

A method is described herein. The method includes performing by an identity system implemented by one or more first computing devices: receiving an authentication request from a service; obtaining region information that is stored in association with an identifier of the service, the region information indicating a region to which the service is assigned; determining whether at least one criterion of an access policy is satisfied based on the region information; determining a level of access to be provided to the service based at least on the determination whether the at least one criterion of the access policy is satisfied; authenticating the service; and generating an access token that indicates that the service is authenticated and the determined level of access.

In one implementation of the foregoing method, the determined level of access to be provided to the service includes one of: no access; limited access; or full access.

In one implementation of the foregoing method, the access policy is: a conditional access policy; or a role-based access control policy.

In one implementation of the foregoing method, the identifier of the service is: an application key issued to the service; a certificate issued to the service or to an application on behalf of the service; or a device identifier corresponding to a hardware authentication device associated with the service.

In one implementation of the foregoing method, said authenticating the service includes: determining that at least one criterion of an authentication policy is satisfied based on the region information; and authenticating the service based at least on the determination that the at least one criterion of the authentication policy is satisfied.

In one implementation of the foregoing method, said determining that at least one criterion of the authentication policy is satisfied based on the region information included in the credential includes: determining that the region to which the service is assigned is not a quarantined region; determining that the region to which the service is assigned is a region that is allowed authentication; or determining that a risk level associated with the region to which the service is assigned satisfies a criterion of the authentication policy.

In one implementation of the foregoing method, said determining whether the at least one criterion of the access policy is satisfied based on the region information includes: determining whether the region to which the service is assigned is a quarantined region; determining whether the region to which the service is assigned is a region that is allowed access; or determining whether a risk level associated with the region to which the service is assigned satisfies a criterion of the access policy.

In one implementation of the foregoing method, the method further includes performing by a target service implemented by one or more second computing devices: receiving from the service an access request for accessing a resource, the access request including the access token; and determining a level of access to the resource based at least on the level of access indicated by the access token.

In one implementation of the foregoing method, the method further includes storing by the identity system the region information in association with the identifier of the service.

A computer-readable storage medium is described herein. The computer-readable storage medium has computer program logic recorded thereon that when executed by at least one processor of an identity system causes the at least one processor to perform a method. The method includes: receiving an authentication request from a service; obtaining region information that is stored in association with an identifier of the service prior to said receiving the authentication request from the service, the region information indicating a region to which the service is assigned; determining that at least one criterion of an authentication policy is not satisfied based on the region information; and denying issuance of an access token to the service based on the determination.

In one implementation of the foregoing computer-readable storage medium, the authentication policy is: a conditional access policy; or a role-based access control policy.

In one implementation of the foregoing computer-readable storage medium, the identifier of the service is: an application key issued to the service; a certificate issued to the service or to an application on behalf of the service; or a device identifier corresponding to a hardware authentication device associated with the service.

In one implementation of the foregoing computer-readable storage medium, said determining that the at least one criterion of the authentication policy is not satisfied based on the region information includes determining that the region to which the service is assigned is a quarantined region.

In one implementation of the foregoing computer-readable storage medium, said determining that the at least one criterion of the authentication policy is not satisfied based on the region information includes determining that a risk level associated with the region to which the service is assigned does not satisfy a criterion of the authentication policy.

In one implementation of the foregoing computer-readable storage medium, said determining that the at least one criterion of the authentication policy is not satisfied based on the region information includes determining that the region to which the service is assigned is not a region that is allowed authentication.

### IX. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, services, identity systems, target services, resources, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A method, comprising:
performing by an identity system implemented by one or more first computing devices:
receiving an authentication request from a service, the authentication request comprising a credential associated with the service, the credential comprising region information that indicates a region to which the service is assigned;
determining whether at least one criterion of an access policy is satisfied based on the region information related to the credential;
determining a level of access to be provided to the service based at least on the determination whether the at least one criterion of the access policy is satisfied;
authenticating the service based on the credential; and
generating an access token that indicates that the service is authenticated and the determined level of access.

2. The method of claim 1, wherein the determined level of access to be provided to the service comprises one of:
no access;
limited access; or
full access.

3. The method of claim 1, wherein the access policy is:
a conditional access policy; or
a role-based access control policy.

4. The method of claim 1, wherein the credential is:
an identity token that was provided to the service by an application platform based on a prior authentication of the application platform by the identity system;
an application key;
a certificate issued to the service or to an application platform on behalf of the service;
an identifier associated with the service; or
a device identifier corresponding to a hardware authentication device associated with the service, or a value derived therefrom.

5. The method of claim 4, wherein the credential is the certificate, the method further comprising:
performing by a certificate provider implemented by one or more second computing devices:
determining the region information based on the region to which the service is assigned;
generating the certificate that includes the region information; and
issuing the certificate to the service or to the application platform on behalf of the service.

6. The method of claim 1, wherein said authenticating the service based on the credential comprises:
determining that at least one criterion of an authentication policy is satisfied based at least on the region information; and
authenticating the service based at least on the determination that the at least one criterion of the authentication policy is satisfied.

7. The method of claim 1, wherein said determining whether at least one criterion of the access policy is satisfied based on the region information included in the credential comprises:
determining whether the region to which the service is assigned is a quarantined region;
determining whether the region to which the service is assigned is a region that is allowed access; or
determining whether a risk level associated with the region to which the service is assigned satisfies a criterion of the access policy.

8. The method of claim 1, further comprising:
performing by a target service implemented by one or more second computing devices:
receiving from the service an access request for accessing a resource, the access request comprising the access token; and
determining a level of access to the resource based at least on the level of access indicated by the access token.

9. A system, comprising:
an identity system implemented by one or more first computing devices that:
receives an authentication request from a service, the authentication request comprising a credential associated with the service, the credential comprising region information that indicates a region to which the service is assigned;
authenticates the service based on the credential; and
provides an access token to the service that includes the region information.

10. The system of claim 9, wherein the credential is:
an identity token that was provided to the service by an application platform based on a prior authentication of the application platform by the identity system;
an application key;
a certificate issued to the service or to an application platform on behalf of the service;
an identifier associated with the service; or
a device identifier corresponding to a hardware authentication device associated with the service, or a value derived therefrom.

11. The system of claim 10, wherein the credential is the certificate, the system further comprising:
a certificate provider implemented by one or more second computing devices that:
determines the region information based on the region the service is assigned to;
generates the certificate that includes the region information; and
issues the certificate to the service.

12. The system of claim 11, wherein the certificate provider is a certificate authority.

13. The system of claim 9, wherein the identity system authenticates the service by:
determining that at least one criterion of an authentication policy is satisfied based on the region information; and
authenticating the service based at least on the determination.

14. The system of claim 9, further comprising:
a target service implemented by one or more second computing devices that:
receives from the service an access request for accessing a resource, the access request including the access token;
determines whether at least one criterion of an access policy is satisfied based on the region information included in the access token; and
determines a level of access to the resource to be provided to the service based at least on the determination whether the at least one criterion of the access policy is satisfied.

15. The system of claim 14, wherein the determined level of access to the resource comprises one of:
no access to the resource;
limited access to the resource; or
full access to the resource.

16. The system of claim 14, wherein the access policy is:
a conditional access policy; or
a role-based access control policy.

17. A computer-readable storage medium having computer program logic recorded thereon that when executed by at least one processor of an identity system causes the at least one processor to perform a method comprising:
receiving an authentication request from a service, the authentication request including a credential associated with the service, the credential including region information that indicates a region to which the service is assigned;
determining that at least one criterion of an authentication policy is not satisfied based on the region information; and
denying issuance of an access token to the service based on the determination.

18. The computer-readable storage medium of claim 17, wherein the credential is:
an identity token that was provided to the service by an application platform based on a prior authentication of the application platform by the identity system;
an application key;
a certificate issued to the service or to an application platform on behalf of the service;
an identifier associated with the service; or
a device identifier corresponding to a hardware authentication device associated with the service, or a value derived therefrom.

19. The computer-readable storage medium of claim 17, wherein said determining that the at least one criterion of the authentication policy is not satisfied based on the region information comprises determining that the region to which the service is assigned is a quarantined region.

20. The computer-readable storage medium of claim 17, wherein said determining that the at least one criterion of the authentication policy is not satisfied based on the region information comprises determining that a risk level associated with the region to which the service is assigned does not satisfy a criterion of the authentication policy.
